(19) United States
(12) Patent Application Publication
(10) Pub. No.: US 2013/0157793 A1
(43) Pub. Date: Jun. 20, 2013

(54) Driven Clutch System

(71) Applicant: Andrzej Dec, Rochester Hills, MI (US)

(72) Inventor: Andrzej Dec, Rochester Hills, MI (US)

(21) Appl. No.: 13/328,630

(22) Filed: Dec. 16, 2011

(51) Int. Cl. F16H 9/12

(52) U.S. Cl. 474/8

(57) ABSTRACT

This disclosure generally includes description of a secondary driven clutch system for a continuously variable transmission. The secondary driven clutch system may be coupled adjacent a shaft that is rotatable about a longitudinal axis. The system may include a movable sheave including a slot, where the movable sheave may be movable closer to or further from a stationary sheave along the longitudinal axis. The slot may be generally at an angle from the longitudinal axis and configured to reduce the longitudinal force needed to move the moveable sheave along the shaft along the longitudinal axis, as compared to a slot generally parallel to the longitudinal axis.

### BACKGROUND

This disclosure relates generally to clutch for a continuous variable transmission (CVT) more particularly to the driven clutch of a CVT, and specifically to a system for reducing the amount of force needed to control the driven clutch an electronic CVT (eCVT).

Split sheave, belt-driven, continuously variable transmissions (CVT's) are used in a variety of recreational type off-road vehicles such as snowmobiles, golf carts, all-terrain vehicles (ATV's), and the like. CVT's, as their name implies, do not require shifting through a series of forward gears, but rather provide a continuously variable ratio that automatically adjusts as the vehicle speeds up or slows down, thus providing relatively easy operation for the rider.

A typical CVT transmission is made up of a split sheave primary drive clutch connected to the output of the vehicle engine (often the crankshaft) and split sheave secondary driven clutch connected (often through additional drive train linkages) to the vehicle axle. An endless, flexible, generally V-shaped drive belt is disposed about the clutches. Each of the clutches has a pair of complementary sheaves, one of the sheaves being movable with respect to the other. The effective gear ratio of the transmission is determined by the positions of the movable sheaves in each of the clutches. The primary drive clutch has its sheaves normally biased apart (e.g., by a coil spring), so that when the engine is at idle speeds, the drive belt does not effectively engage the sheaves, thereby conveying essentially no driving force to the secondary driven clutch. The secondary driven clutch has its sheaves normally biased together (e.g., by a torsion spring working in combination with a helix-type cam, as described below, so that when the engine is at idle speeds the drive belt rides near the outer perimeter of the driven clutch sheaves.

The spacing of the sheaves in the primary drive clutch usually may be controlled by centrifugal flyweights. Centrifugal flyweights are typically connected to the engine shaft so that they rotate along with the engine shaft. As the engine shaft rotates faster (in response to increased engine speed) the flyweights also rotate faster and pivot outwardly, urging the movable sheave toward the stationary sheave. The more outwardly the flyweights pivot, the more the moveable sheave is moved toward the stationary sheave. This pinches the drive belt, causing the belt to begin rotating with the drive clutch, the belt in turn causing the driven clutch to begin to rotate. Further movement of the drive clutch's movable sheave toward the stationary sheave forces the belt to climb outwardly on the drive clutch sheaves, increasing the effective diameter of the drive belt path around the drive clutch. Thus, the spacing of the sheaves in the drive clutch changes based on engine speed. The drive clutch therefore can be said to be speed sensitive.

As the sheaves of the drive clutch pinch the drive belt and force the belt to climb outwardly on the drive clutch sheaves, the belt (not being relatively stretchable) is pulled inwardly between the sheaves of the driven clutch, decreasing the effective diameter of the drive belt path around the driven clutch. This movement of the belt outwardly and inwardly on the drive and driven clutches, respectively, smoothly changes the effective gear ratio of the transmission in variable increments.

Split-sheave, belt driven CVTs are typically purely mechanical devices, that is, the mechanical parameters are established when the CVT is assembled. Once the CVT is assembled, the gear ratio depends on these set mechanical parameters. For example, the gear ratio depends on the distance between the drive clutch sheaves. The distance between the drive clutch sheaves is determined by the amount of force produced by the flyweights against the movable sheave. As the flyweights are attached to the engine shaft, the amount of the flyweight force depends on the speed of rotation of the engine shaft. Thus, with these prior devices, it is difficult to modify the gear ratio without disassembling the CVT and readjusting the mechanical parameters.

Conversely, electronic CVTs control the distance between the sheaves in controlled electrically and electronically via stepper motors, gear and sprocket drives, and the like. The motor may force the sheaves together to control the distance of the belt from the shaft, thus controlling the ratio and speed. This offers advantageous of flexibility of design and control.

As noted above, the secondary driven clutch sheaves may be held apart via a spring, or other biasing device. A certain amount of force is needed to overcome the biasing force to move the driven sheaves together. The size, or biasing force, of the spring, and the size of the motor are considerations when designing a secondary driven eCVT clutch system. What is needed is a system for reducing the amount of energy needed to control a secondary driven eCVT clutch.

### SUMMARY

The present disclosure is directed to systems and methods which provide relatively lower power and motor size to control a secondary driven eCVT clutch. The moveable sheave in the clutch system may include a generally angled slot, which guide rollers reside in to impart force on the sheave. The sheave may be coupled to a position system, which may be driven by a motor, to move the moveable sheave with respect to a non-moveable sheave. The angular slot may reduce the amount of longitudinal force required to move the moveable sheave. This may decrease the power and size of the motor needed to control the movement of the moveable sheave, when compared to a sheave with a generally longitudinal slot.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The accompanying drawings, which are incorporated in and form part of the specification in which like numerals designate like parts, illustrate embodiments of the present disclosure and together with the description, serve to explain the principles of the disclosure. In the drawings:

FIG. 1 is plan view of a CVT system according to an embodiment of the disclosure.

FIG. 2 is plan view of a driven eCVT clutch system according to an embodiment.

FIG. 3 is plan view of a driven eCVT clutch system according to an embodiment.

### DETAILED DESCRIPTION

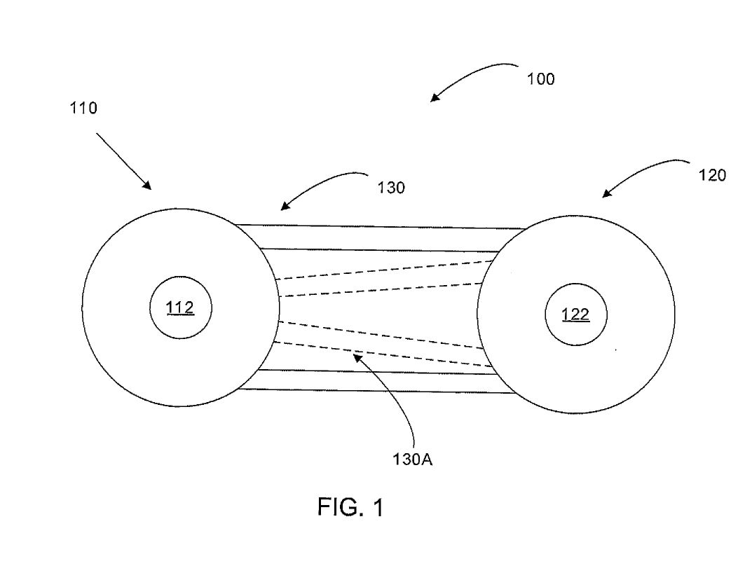

FIG. 1 shows a plan view of a CVT system 100. System 100 may include a primary drive pulley 110, a secondary driven pulley 120, and a belt 130. Each of primary drive pulley 110 and secondary driven pulley 120 may include a fixed or stationary sheave (not shown) and a moveable sheave (not shown). The moveable sheave may be moved with respect to the stationary sheave to allow belt 130 to move within the pulleys 110, 120. This may change the distance of belt 130 with respect to the drive 112 and driven shafts 122, thereby changing an effective gear ratio, which in turn changes the speed of driven shaft. Typically drive shaft 112 is coupled to the shaft of a motor, and runs at a generally constant speed, once the motor ramps up to speed.

Primary drive pulley 110 may be mounted and/or generally coupled to drive shaft 112. Similarly, a secondary driven pulley 120 may be coupled to a driven shaft 122. This may be accomplished via many known methods and systems. Any method or system of coupling capable of being used for this purpose may be used. This disclosure is not limited by the method or system of coupling of the pulleys to the respective shafts.

As shown, if the moveable sheave of the primary drive pulley 110 is moved away from the stationary sheave, belt 130A would ride further down in primary drive pulley 110. This would cause the speed of driven shaft 122 to generally decrease. If the moveable sheave of secondary driven pulley 122 is moved away from the stationary sheave, this would cause the belt 130A to ride lower in the driven pulley 120, which would cause the rotational speed of driven shaft 122 to generally increase (if the primary drive shaft 112 speed was held constant). In this manner, the ration of speed of the relatively constant rotational speed of the drive shaft 112 and the driven shaft 122 can be constantly varied and controlled.

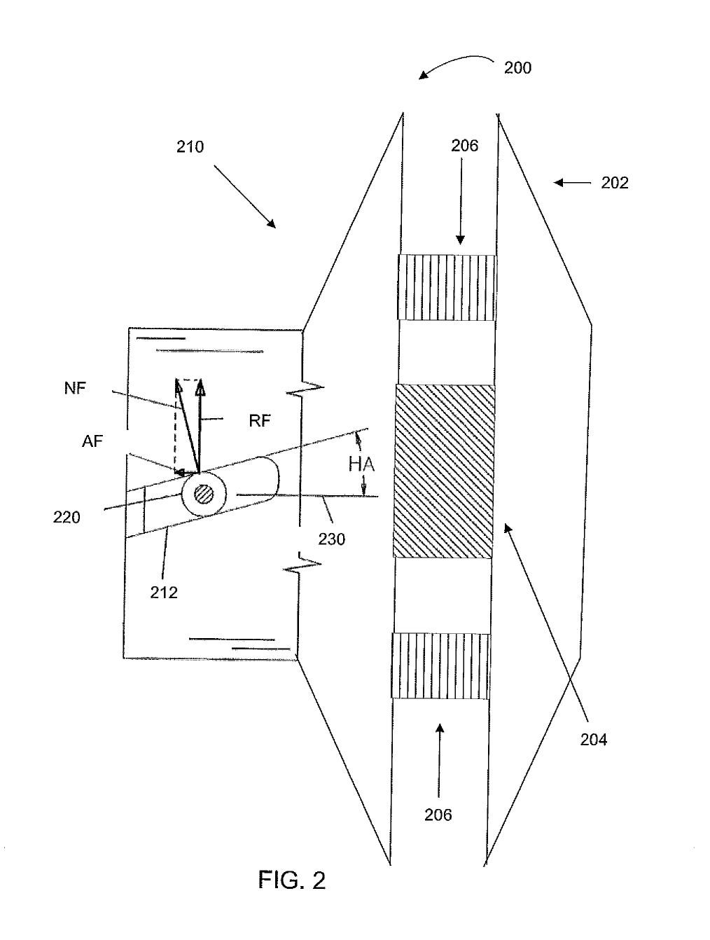

FIG. 2 shows a secondary driven clutch system 200 according to an embodiment. System 200 may include a stationary sheave 202, a moveable sheave 210, a driven shaft 204 and a belt 206. Moveable sheave 210 may be moved with respect to stationary sheave 202, which causes belt 206 to move toward and away from shaft 204. This would cause the ration of rotational speed of the drive shaft (not shown) to driven shaft 204 to change, and thereby change the speed of the vehicle this system 200 is a part of.

Moveable sheave 210 may include one or more slot(s) 212. Within slot 212 may be roller(s) 220. Moveable sheave 210 may be coupled to a position motor (not shown), which may be controlled to control the position of moveable sheave 210 with respect to stationary sheave 202. The position motor may be couples to the rollers in any manner which may be operable to impart force upon moveable sheave 210. It will be appreciated that this may be accomplished with many configurations, and the scope of this disclosure is not limited by the configuration, system and/or method of coupling a positional motor to moveable sheave 210.

Through roller(s) 220, force may be transmitted to moveable sheave 210 from the position system, which includes position motor. The relative movement of moveable sheave 210 with respect to stationary sheave 202 may be determined by the shape of slot(s) 212. In the embodiment shown in FIG. 2, the shape of slot(s) 212 is generally helical, with a helix angle HA of about 20 degrees as measured from longitudinal axis 230. Longitudinal axis 230 is generally parallel to driven shaft 204. HA may be in the range of about 5-50 degrees.

The force imparted upon moveable sheave 210 by the position system may be generally represented by a radial force RF generated by belt 206, and is transformed by the shape of slot(s) 212 to a normal force NF, and axial force AF. Axial force AF pushes moveable sheave 210 toward stationary sheave 202. The larger the helix angle of HA, the larger axial force AF, which may result in less power required from an electric positional motor (not shown) to move moveable sheave 210 toward stationary sheave 202. The motor must also be sized with enough initial torque to start the movement of moveable sheave 210 toward stationary sheave 202. However, the size, power, and cost of the positional motor may be reduced.

Moveable sheave 210 may typically be biased away from stationary sheave 202 via a spring. The positional motor must be sized to overcome this biasing force. With the design of slot(s) 212, the size, power, and/or cost, and/or combinations thereof, of the positional motor may be generally reduced then if slot(s) 212 were generally parallel to longitudinal axis 220.

The relative motion between moveable sheave 210 and stationary sheave 202 may be determined and/or defined by the configuration of slot 212, which guides roller 220. Helix angle HA of slot 212 aids in moving moveable sheave 210, resulting lower initial torque and lower power requirements for positional motor.

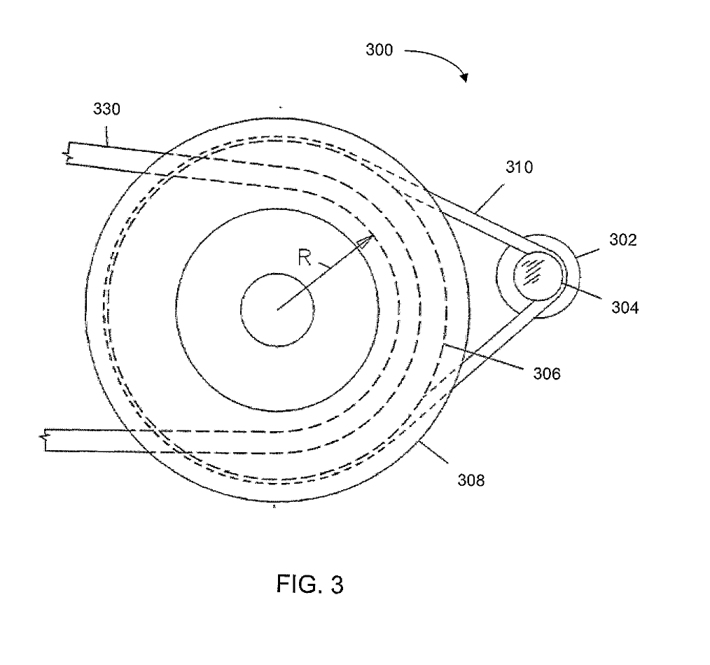

FIG. 3 shows a portion of drive system 300 used for moving a moveable sheave. System 300 may include a positional motor 302, coupled to a position sprocket 304, position belt 310, sheave sprocket 306, and a stationary sheave 308. Position belt 310 may contact and generally encircle a portion of position sprocket 304 and sheave sprocket 306.

In an embodiment, position belt 310 may be a toothed-type belt or other belt suitable for use in this system. Belt 330 contacts sheave 308 in a manner described above to impart force upon the secondary driven clutch.

In an embodiment, change of the position of the moveable sheave (not shown) may be accomplished in the following manner. Positional motor 302 may rotate sheave sprocket 306 via position belt 310 and positional sprocket 304. This may cause moveable sheave to move because sheave sprocket 304 may be coupled (either directly or indirectly) to moveable sheave. Sheave sprocket 306 may be coupled to moveable sheave any suitable manner, including but not limited to, intertwined splines, worm or other gear, or any other manner suitable for this purpose.

As movable sheave moves toward stationary sheave 308, the distance R belt 330 is from the shaft may increase, thereby increasing the rotational speed of the secondary driven clutch.

The relative motion between moveable sheave and stationary sheave 308 may be determined and/or defined by the configuration of slot 212, which guides roller 220. Helix angle HA of slot 212 aids in moving moveable sheave, resulting lower initial torque and lower power requirements for positional motor 302.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The disclosure disclosed herein may suitably be practiced in the absence of any element that is not specifically disclosed herein.

What is claimed is:

1. A secondary driven clutch system for a continuously variable transmission, the secondary driven clutch system coupled to a shaft that is rotatable about a longitudinal axis, comprising:
a stationary sheave coupled adjacent the shaft;
a movable sheave comprising a slot, and coupled adjacent the shaft, the movable sheave being movable closer to, or further from, said stationary sheave along the longitudinal axis;
a positional motor coupled to the moveable sheave at least in part via said slot, and configured to cause said moveable sheave to move closer or further from the stationary sheave;
wherein said slot is generally at an angle from said longitudinal axis and configured to reduce the longitudinal force needed to move said moveable sheave relative to said stationary sheave, as compared to a slot generally parallel to said longitudinal axis.

2. The secondary driven clutch system of claim 1, wherein the reduction in force allows for use of a generally less powerful motor.

3. The secondary driven clutch system of claim 1, wherein the reduction in force allows for use of a generally smaller motor.

4. The secondary driven clutch system of claim 1, wherein the reduction in force allows for use of a generally less expensive motor.

5. The secondary driven clutch system of claim 1, wherein the angle is about 5-50 degrees from the longitudinal axis.

6. The secondary driven clutch system of claim 5, wherein the angle is about 20 degrees when measured from the longitudinal axis.

7. The secondary driven clutch system of claim 1, wherein the motor is coupled to the slot via rollers generally within the slot.

8. The secondary driven clutch system of claim 1, wherein the motor is coupled to the slot via a belt and gear drive system.

9. The secondary driven clutch system of claim 1, wherein the reduction in force allows for a reduction in initial torque to move said moveable sheave.

10. A vehicle comprising a continuously variable transmission system wherein the continuously variable transmission system comprises:
a secondary driven clutch system for the continuously variable transmission, the secondary driven clutch system coupled adjacent a shaft that is rotatable about a longitudinal axis, comprising:
a stationary sheave coupled adjacent the shaft;
a movable sheave positioned about the shaft, the movable sheave being movable closer to or further from the stationary sheave along the longitudinal axis;
a motor coupled to the moveable sheave via a slot and configured to cause said moveable sheave closer or further from the stationary sheave;
wherein said slot is generally at an angle from said longitudinal axis and configured to reduce the longitudinal force needed to move said moveable sheave relative to said stationary sheave, with respect to a moveable sheave with a slot generally parallel to said longitudinal axis.

11. The vehicle of claim 10, wherein the reduction in force allows for use of a generally less powerful motor.

12. The vehicle of claim 10, wherein the reduction in force allows for use of a generally smaller motor.

13. The vehicle of claim 10, wherein the reduction in force allows for use of a generally less expensive motor.

14. The vehicle of claim 10, wherein the angle is generally 5-50 degrees from the longitudinal axis.

15. The vehicle of claim 14, wherein the angle is generally 20 degrees from the longitudinal axis.

16. The vehicle of claim 10, wherein the motor is coupled to the slot via rollers generally within the slot.

17. The secondary driven clutch system of claim 10, wherein the motor is coupled to the slot via a belt and gear drive system.

18. A secondary driven clutch system for a continuously variable transmission, the secondary driven clutch system coupled adjacent a shaft that is rotatable about a longitudinal axis, comprising:
a movable sheave comprising a slot, and coupled adjacent the shaft, the movable sheave being movable closer to or further from a stationary sheave along the longitudinal axis;
wherein said slot is generally at an angle from said longitudinal axis and configured to reduce the longitudinal force needed to move said moveable sheave along the shaft along the longitudinal axis, as compared to a slot generally parallel to said longitudinal axis.

19. The secondary driven clutch system of claim 18, wherein the angle is about 5-50 degrees from the longitudinal axis.

20. The secondary driven clutch system of claim 19, wherein the angle is about 20 degrees when measured from the longitudinal axis.
